(19) United States
(12) Patent Application Publication
(10) Pub. No.: US 2026/0087721 A1
(43) Pub. Date: Mar. 26, 2026

(54) LIGHT DISTRIBUTION CORRECTION OF UNEVEN TEXTURE MAPS FOR THREE-DIMENSIONAL (3D) OBJECTS

(71) Applicants: SONY GROUP CORPORATION, TOKYO (JP); SONY CORPORATION OF AMERICA, NEW YORK, NY (US)

(72) Inventors: CHEN FU, SAN JOSE, CA (US); MOHAMMAD GHARAVI ALKHANSARI, SAN JOSE, CA (US)

(21) Appl. No.: 18/895,225

(22) Filed: Sep. 24, 2024

(51) Int. Cl. G06T 15/04; G06T 15/50

(52) U.S. Cl. CPC G06T 15/04; G06T 15/50

(57) ABSTRACT

An electronic device and method for light distribution correction of uneven texture maps for three-dimensional (3D) objects is disclosed. The electronic device captures an image of an object that is illuminated by a set of lighting patterns. The electronic device determines a brightness distribution of the captured image based on a location of at least one camera of the set of cameras. The electronic device computes distance of each pixel associated with the captured image and the set of cameras. The electronic device generates a light map of the captured image of the object based on the determined brightness distribution and the computed distance. Further, the electronic device updates a brightness intensity of a texture map associated with the captured image, based on the generated light map, and renders the captured image based on the updated brightness intensity of the texture map.

### CROSS-REFERENCE TO RELATED APPLICATIONS/INCORPORATION BY REFERENCE

None

### FIELD

Various embodiments of the disclosure relate to light distribution correction. More specifically, various embodiments of the disclosure relate to an electronic device and method for light distribution correction of uneven texture maps for three-dimensional (3D) objects.

### BACKGROUND

Advancements in the field of three-dimensional (3D) computer graphics have provided the ability to create 3D models and visualize real objects in a 3D computer graphics environment. A 3D model may be a static 3D mesh that resembles the shape of a particular object. Typically, the creation of realistic human faces in digital form may involve the use of 3D face models and 2D surface textures. These models and textures may be derived from various sources, including laser scans and high-resolution photographs. The 3D shape and 2D texture of a face may be represented in a computational face space, which shows how each face differs from an average face in terms of these two aspects. The texture and shape of a face can be normalized or adjusted to match an average or standard. This process may involve morphing texture maps from individual faces onto an average head shape and morphing an average texture onto the shape of each individual face. This normalization process may increase the attractiveness of faces. However, light cages may have uneven light distribution in different 3D locations across the cage, which may contribute to the uneven texture maps that have this lighting effects baked in.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for light distribution correction of uneven texture maps for 3D objects is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for light distribution correction of uneven texture maps for three-dimensional (3D) objects, in accordance with an embodiment of the disclosure.

FIG. 2 is a block diagram that illustrates an exemplary electronic device of FIG. 1, in accordance with an embodiment of the disclosure.

FIG. 3 is a block diagram that illustrates an exemplary processing pipeline for light distribution correction of uneven texture maps for three-dimensional (3D) objects, in accordance with an embodiment of the disclosure.

FIG. 4 is a diagram that illustrates an exemplary scenario of light distribution correction based on image of body portion of a subject, in accordance with an embodiment of the disclosure.

FIG. 5 is a diagram that illustrates an exemplary scenario of light distribution correction based on image of a whiteboard, in accordance with an embodiment of the disclosure.

FIG. 6 is a diagram that illustrates an exemplary processing pipeline for light distribution correction of uneven texture maps for three-dimensional (3D) objects, in accordance with an embodiment of the disclosure.

### DETAILED DESCRIPTION

The following described implementation may be found in the electronic device and method for light distribution correction of uneven texture maps for 3D objects. Exemplary aspects of the disclosure may provide an electronic device (for example, a server, a desktop, a laptop, or a personal computer) that may execute correct light distribution of uneven texture maps for 3D objects. The electronic device may capture an image of an object that is illuminated by a set of lighting patterns. The electronic device may determine a brightness distribution of the captured image based on a location of at least one camera of the set of cameras. The electronic device may compute a distance of each pixel associated with the captured image and the set of cameras. The electronic device may generate a light map of the captured image of the object based on the determined brightness distribution and the computed distance. Further, the electronic device may update a brightness intensity of a texture map associated with the captured image, based on the generated light map, and render the captured image based on the updated brightness intensity of the texture map.

Typically, the creation of realistic human faces in digital form may involve the use of 3D face models and 2D surface textures. These models and textures may be derived from various sources, including laser scans and high-resolution photographs. The 3D shape and 2D texture of a face may be represented in a computational face space, which shows how each face differs from an average face in terms of these two aspects. The texture and shape of a face may be normalized or adjusted to match an average or standard. This process may involve morphing the texture maps from individual faces onto the average head shape and morphing the average texture onto the shape of each individual face. This normalization process may increase the attractiveness of faces. In the past, methods have been developed to generate different types of maps, including diffuse, specular, normal, and height maps, from a light cage. However, light cages may have uneven light distribution in different 3D locations across the cage, which contributes to the uneven texture maps that have this lighting effects baked in. To create a realistic rendering of human skin, textures used for the skin shader may be needed to be carefully considered. Different parts of the body have different appearances, and these differences need to be taken into account when creating a diffuse map of the skin. Specular maps are also important in creating a photo-real face, as they determine the ‘look’ of a model and how it reacts to various lighting conditions.

In order to address the requirements, the present disclosure introduces a method to correct uneven lighting effect on the textured maps of the 3D object, such as face. The present disclosure further introduces the creation of an evenly lit texture map of the 3D object without any prior knowledge of the lighting conditions. Additionally, the present disclosure may produce an evenly lit texture for a face based on image of a whiteboard. This approach may be commonly used in case of texture maps correction for the image of a face or skin covered by tattoos or other features, as it may compensate for the uneven lighting and create consistency and well-lit texture map across the captured image.

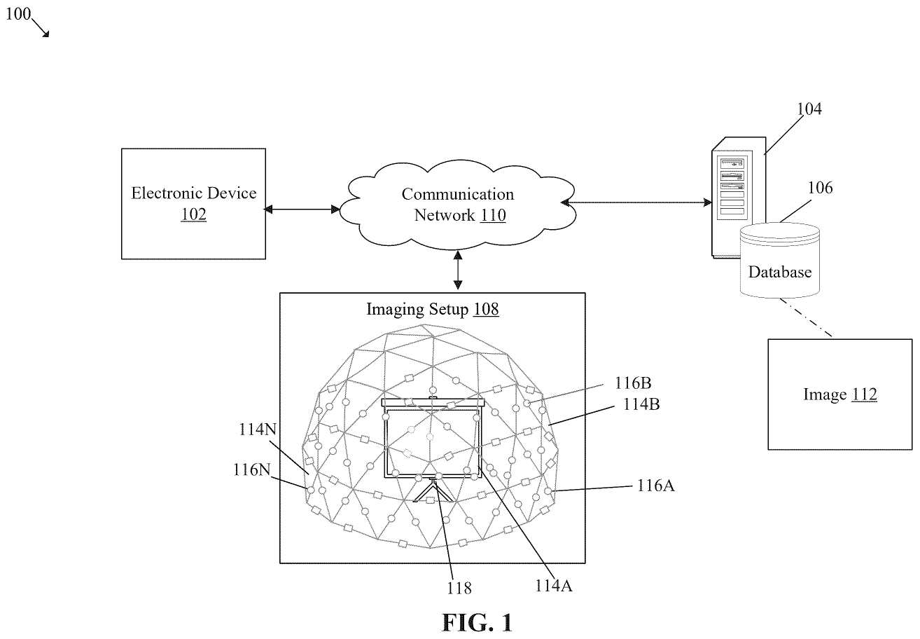

FIG. 1 is a block diagram that illustrates an exemplary network environment for light distribution correction of uneven texture maps for three-dimensional (3D) objects, in accordance with an embodiment of the disclosure. With reference to FIG. 1, there is shown a network environment 100. The network environment 100 may include an electronic device 102, a server 104, a database 106, an imaging setup 108, and a communication network 110. The database 106 may include an image 112. The imaging setup 108 may include a first structure 114A, a second structure 114B, . . . and an Nth structure 114N.

With reference to FIG. 1, there is further shown a set of cameras 116 that may be installed on a 3D cage structure that includes the first structure 114A, the second structure 114B, and the Nth structure 114N. The set of cameras 116 may include, for example, a first camera 116A, a second camera 116B, . . . and an Nth camera 116N. The electronic device 102 and the server 104 may be communicatively coupled to one another, via the communication network 110. In FIG. 1, there is further shown an object 118.

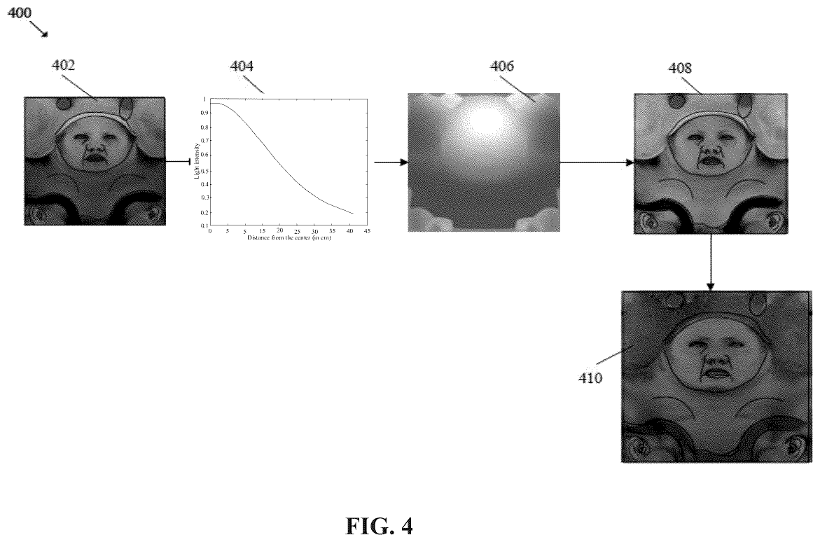

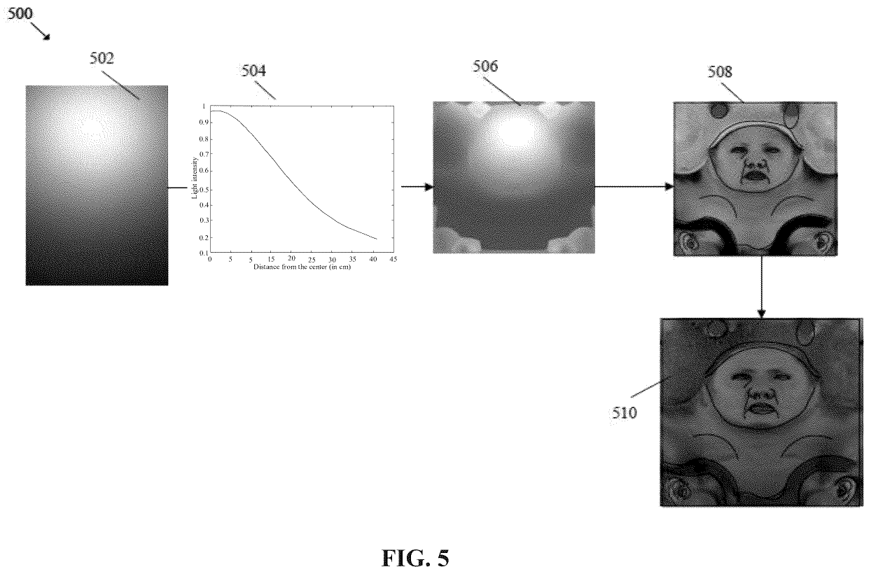

The electronic device 102 may include suitable logic, circuitry, interfaces, and/or code that may be configured to capture the image 112 of the object 118 that may be illuminated by a set of lighting patterns. The electronic device 102 may determine a brightness distribution of the captured image 112 based on a location of at least one camera (for example, at least one the first camera 116A, the second camera 116B, . . . and the Nth camera 116N) of the set of cameras 116. The electronic device 102 may compute a distance of each pixel associated with the captured image 112 and the set of cameras 116. The electronic device 102 may generate a light map (for example, a light map 406 in FIG. 4 or a light map 506 in FIG. 5) of the captured image 112 of the object 118 based on the determined brightness distribution and the computed distance. Further, the electronic device 102 may update a brightness intensity of a texture map associated with the captured image 112, based on the generated light map. Furthermore, the electronic device 102 may render the captured image 112 based on the updated brightness intensity of the texture map (for example, update a diffused map at 408 and a specular map at 410). Examples of the electronic device 102 may include, but are not limited to, a computing device, a smartphone, a cellular phone, a mobile phone, a gaming device, a mainframe machine, a server, a computer workstation, and/or a consumer electronic (CE) device.

The server 104 may include suitable logic, circuitry, and interfaces, and/or code that may be configured to execute operations, such as data/file storage, 3D rendering, or 3D reconstruction operations (such as a photogrammetric reconstruction operation). In one or more embodiments, the server 104 may store the image 112 and may execute at least one operation associated with the electronic device 102. The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the electronic device 102, as two separate entities. In certain embodiments, the functionalities of the server 104 can be incorporated in its entirety or at least partially in the electronic device 102 without a departure from the scope of the disclosure. In certain embodiments, the server 104 may host the database 106. Alternatively, the server 104 may be separate from the database 106 and may be communicatively coupled to the database 106.

The database 106 may include suitable logic, interfaces, and/or code that may be configured to store the image 112 or metadata associated with the image 112. For example, the metadata may include an identifier of an image-capture device that captures the image 112, a lighting pattern used at the time of capture, or an identifier of a viewpoint from where the image 112 is captured, or an index value to indicate a position of the image 112. The database 106 may be stored or cached on a device, such as a server (e.g., the server 104) or the electronic device 102. The device storing the database 106 may be configured to receive a query for the image 112 or the metadata. In response, the device that stores the database 106 may retrieve and provide the image 112 or the metadata to the electronic device 102.

In some embodiments, the database 106 may be hosted on a plurality of servers stored at the same or different locations. The operations of the database 106 may be executed using hardware, including a processor, a microprocessor (e.g., to perform or control performance of one or more operations), a field-programmable gate array (FPGA), or an application-specific integrated circuit (ASIC). In some other instances, the database 106 may be implemented using software.

The imaging setup 108 may correspond to a 3D cage structure onto which the set of cameras 116 may be disposed and oriented to scan the object 118 inside the 3D cage structure from a plurality of viewpoints. The imaging setup 108 may include the plurality of structures 114, each of which may be connected at certain locations to form a cage-like structure (e.g., a 3D dome structure as shown in FIG. 1). The present disclosure may not be limited to any particular shape of the 3D cage structure. In some embodiments, the shape of the cage-like structure may be cylindrical, cuboidal, or any arbitrary share, depending on the requirement of the volumetric studio/capture. In some embodiments, each of the plurality of structures 114 may have the same or different dimensions depending on the requirement of the volumetric studio/capture. In addition to the set of cameras 116, a plurality of audio capture devices (not shown), and/or a plurality of light sources (not shown) may be disposed at certain locations on the plurality of structures 114 to form the imaging setup 108.

By way of example, and not limitation, each structure of the plurality of structures 114 may include a mount to hold at least one camera (represented by a circle in FIG. 1) and at least one processing device. As shown in FIG. 1, each structure (e.g., a truss) may include a frame of a particular material (e.g., metal, plastic, or fiber) to hold at least one of a camera, a processing device, an audio-capture device, and a light source (e.g., a flash). Different 3D structures of the same or different shapes can be connected to form the imaging setup 108. In an embodiment, the processing device may be the electronic device 102.

In some embodiments, a movable imaging setup may be created. In such an implementation, each of the plurality of structures 114 of the movable imaging setup may correspond to an unmanned aerial vehicle (UAV) and the set of cameras 116, the plurality of light sources, and/or other devices may be mounted on a plurality of unmanned aerial vehicles (UAVs).

The communication network 110 may include a communication medium through which the electronic device 102 and the server 104 may communicate with one another. The communication network 110 may be one of a wired connection or a wireless connection. Examples of the communication network 110 may include, but are not limited to, the Internet, a cloud network, Cellular or Wireless Mobile Network (such as Long-Term Evolution and 5^{th} Generation (5G) New Radio (NR)), a satellite network (such as, a network of set of low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 110 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In operation, the electronic device 102 may be configured to capture, by use of the set of cameras 116, the image 112 of the object 118 that may be illuminated by the set of lighting patterns. By way of example, and not limitation, the set of lighting patterns may include one or more of a cross-polarized omni-directional lighting pattern, gradient lighting patterns, and polarized lighting patterns, including a cross-polarized lighting pattern and a parallel-polarized lighting pattern.

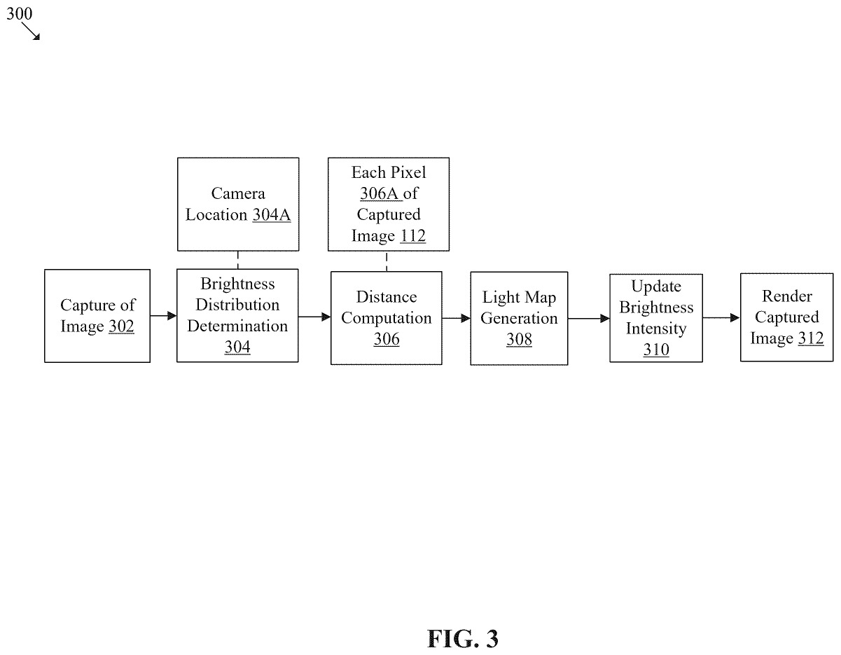

In an exemplary embodiment, the object 118 may be at least one of a whiteboard or a body portion of a subject placed in the center of the imaging setup 108. For instance, the object 118 may be a human head (with face) and the image 112 may be captured from the imaging setup 108 that may operate as a polarization-based light cage The object 118 may be scanned via one or more cameras 116 of the imaging setup 108 from a plurality of viewpoints to obtain the image 112. In order to obtain high-fidelity reflectance and normal/height maps for the object 118, the object 118 must be exposed to different lighting patterns while capturing images (for example, the image 112) of the object 118 from different viewpoints. Details related to the image capture are further provided, for example, in FIG. 3 (at 302).

In some instances, when the object 118 is scanned to capture the image 112, the object 118 may need to stay still throughout the scanning phase. However, there may be some unavoidable movement (e.g., head movement) of the object 118. Actual between-frame movement may be assumed to be small. The rigid motion may be estimated and removed by performing patch matching between images or frames to obtain a set of motion-corrected images.

The electronic device 102 may be configured to determine a brightness distribution of the captured image 112 based on a location of at least one camera of the set of cameras 116. By way of example, the brightness distribution may be determined based on camera parameters associated with each camera of the set of cameras 116. The camera parameters may be determined based on a texture generation method. Details of such methods have been omitted from the disclosure for the sake of brevity. An example brightness distribution determination is provided, for example, in FIG. 4 and FIG. 5.

The electronic device 102 may be configured to compute a distance of each pixel associated with the captured image 112 and the set of cameras 116. By way of example, the electronic device 102 may be configured to determine camera parameters associated with each camera of the set of cameras 116 to obtain a three-dimensional (3D) location of each pixel associated with the captured image 112. Further, a center of the imaging setup 108 may be estimated based on the location of at least one camera of the set of cameras 116. Furthermore, the brightness distribution may be determined based on the obtained 3D location of each pixel and the estimated center of the imaging setup 108.

In an exemplary embodiment, the electronic device 102 may be configured to generate a 3D mesh of the object 118 based on the capture of image 112 by use of the set of cameras 116 in the imaging setup 108 to determine the center of the imaging setup 108. By way of example, and not limitation, the 3D mesh may be generated from a set of images using a photogrammetry-based method (such as structure from motion (SfM)), a method which requires stereoscopic images, or a method which requires monocular cues (such as shape from shading (SfS), photometric stereo, or shape from texture (SfT)). Details of such methods have been omitted from the disclosure for the sake of brevity. The 3D mesh may be an untextured mesh that resembles the 3D shape of the object 118. The 3D mesh may use polygons to define the shape or the geometry of the object 118.

For example, in case, the imaging setup 108 may be a spherical light cage (as shown in FIG. 1), then the camera parameters associated with each camera of the set of cameras 116 may convert the image 112 (for example, a 2D image) space into the 3D mesh. A real-world 3D location for each pixel of the 2D image may be determined based on the conversion of the 2D image into the 3D mesh. Further, the location of each camera of the set of cameras 116 in a spherical light cage may be computed to determine the center of the spherical light cage. Further, the electronic device 102 may be configured to determine relationship between the determined brightness distribution and the estimated center of the spherical light cage. In an exemplary embodiment, the relationship between the brightness distribution and the center of the spherical light cage may be represented in a graphical form such as a polynomial curve. An example of the distance of each pixel is provided, for example, in FIG. 3, FIG. 4 and FIG. 5.

The electronic device 102 may be configured to generate a light map (for example, a light map at 406 or a light map at 506) of the captured image 112 of the object 118 based on the determined brightness distribution and the computed distance. By way of example, the light map of the captured image 112 generation may be based on the relationship between the determined brightness distribution and the estimated center of the imaging setup 108. An example of the light map is provided, for example, in FIG. 3, FIG. 4 and FIG. 5.

The electronic device 102 may be configured to update a brightness intensity of a texture map associated with the captured image 112, based on the generated light map (for example, the light map at 406 or the light map at 506). By way of example, the texture map may correspond to at least one of a diffuse texture map, a specular texture map, or a normal texture map. For example, the diffuse texture map (such as, the diffused map 408 or the diffused map 508) may be updated based on the generated light map. Alternatively, the specular texture map (such as, the specular map 410 or the specular map 510) may be updated based on the generated light map. An example of the update of texture map is provided, for example, in FIG. 3, FIG. 4 and FIG. 5.

The electronic device 102 may be configured to render the captured image 112 based on the updated brightness intensity of the texture map. By way of example, the updated brightness intensity of the texture map corresponds to at least one of update of the diffuse texture map, the specular texture map, or the normal texture map. For example, the image 112 may be rendered to update the brightness intensity of diffuse texture map (such as, the diffused map 408 or the diffused map 508). Alternatively, the image 112 may be rendered to update the brightness intensity of the specular texture map (such as, the specular map 410 or the specular map 510). An example of render of the captured image 112 is provided, for example, in FIG. 3, FIG. 4 and FIG. 5.

Typically, the creation of realistic human faces in digital form may involve the use of 3D face models and 2D surface textures. These models and textures may be derived from various sources, including laser scans and high-resolution photographs. The 3D shape and 2D texture of a face may be represented in a computational face space, which shows how each face differs from an average face in terms of these two aspects. The texture and shape of a face can be normalized or adjusted to match an average or standard. This process may involve morphing the texture maps from individual faces onto the average head shape and morphing the average texture onto the shape of each individual face. The normalization process has been found to increase the attractiveness of faces. In the past, methods have been developed to generate different types of maps, including diffuse, specular, normal, and height maps, from a spherical light cage. However, spherical light cages have uneven light distribution in different 3D locations across the cage, which contributes to the uneven texture maps that have this lighting effects baked in. To create a realistic rendering of human skin, textures used for the skin shader need to be carefully considered. Different parts of the body have different appearances, and these differences need to be taken into account when creating a diffuse map of the skin. Specular maps are also important in creating a photo-real face, as they determine the ‘look’ of a model and how it reacts to various lighting conditions.

In order to address the requirements, the present disclosure introduces a method to correct uneven lighting effect on the textured maps of the 3D object (such as, the object 118), for example, a face of a person. The present disclosure further introduces the creation of an evenly lit texture map of the 3D object 118 without any prior knowledge of the lighting conditions. Additionally, the present disclosure may produce an evenly lit texture for a face based on image of the whiteboard. This approach may be commonly used in case of texture maps correction for the image of a face or skin covered by tattoos or other features, as it may compensate for the uneven lighting and create consistency and well-lit texture map across the captured image 112.

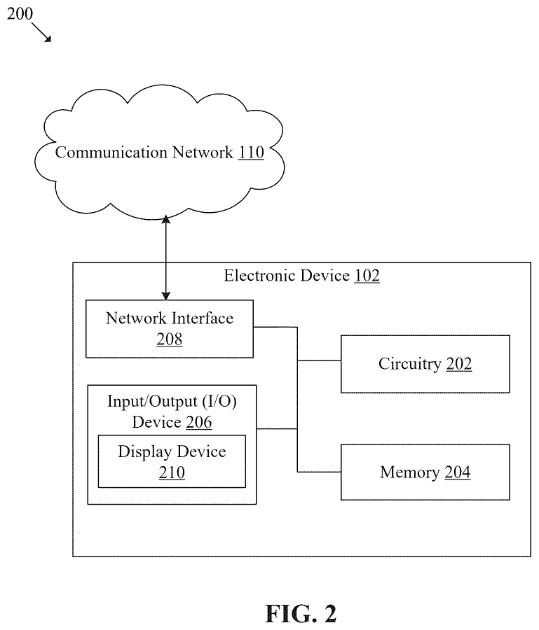

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown the electronic device 102. The electronic device 102 may include circuitry 202, a memory 204, an input/output (I/O) device 206, and a network interface 208. The input/output (I/O) device 206 may include a display device 210.

The circuitry 202 may include suitable logic, circuitry, and/or interfaces that may be configured to execute program instructions associated with different operations to be executed by the electronic device 102. The operations may include image capture, brightness distribution determination, distance computation, light map generation, brightness intensity update, and image rendering. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The memory 204 may be configured to store the image 112 and metadata associated with the image 112. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. For example, the I/O device 206 may receive a first user input indicative of the selection of the image 112. In another example, the I/O device 206 may receive a second user input including an instruction to capture the image 112 of the object 118. The I/O device 206 may be further configured to display the image 112 and/or the 3D mesh. The I/O device 206 may include the display device 210. Examples of the I/O device 206 may include, but are not limited to, a touch screen, the display device 210, a keyboard, a mouse, a joystick, a microphone, or a speaker.

The network interface 208 may include suitable logic, circuitry, interfaces, and/or code that may be configured to facilitate communication between the electronic device 102 and the server 104 via the communication network 110. The network interface 208 may be implemented by use of various known technologies to support wired or wireless communication of the electronic device 102 with the communication network 110. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The display device 210 may include suitable logic, circuitry, and interfaces that may be configured to display a set of images that may include the image 112, the 3D mesh and/or the image 112 with updated brightness intensity (after processing). The display device 210 may be a touch screen which may enable a user (e.g., the user 120) to provide a user-input via the display device 210. The touch screen may be at least one of a resistive touch screen, a capacitive touch screen, or a thermal touch screen. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210 may refer to a display screen of a head mounted device (HMD), a smart-glass device, a see-through display, a projection-based display, an electro-chromic display, or a transparent display. Various operations of the circuitry 202 for generation of reflectance maps for relightable 3D models are described further, for example, in FIG. 3.

FIG. 3 is a block diagram that illustrates an exemplary processing pipeline for light distribution correction of uneven texture maps, in accordance with an embodiment of the disclosure. FIG. 3 is explained in conjunction with elements from FIG. 1 and FIG. 2. With reference to FIG. 3, there is shown an exemplary processing pipeline 300 that illustrates exemplary operations from 302 to 312. The exemplary operations 302 to 312 may be executed by any computing system, for example, by the electronic device 102 of FIG. 1 or by the circuitry 202 of FIG. 2. The exemplary processing pipeline 300 further illustrates a camera location 304A and each pixel 306A of the captured image 112.

At 302, an image may be captured. The circuitry 202 may capture, by use of the set of cameras 116 in the imaging setup 108, the image 112 of the object 118 that may be illuminated by the set of lighting patterns. By way of example, and not limitation, the set of lighting patterns may include one or more of a cross-polarized omni-directional lighting pattern, gradient lighting patterns, and polarized lighting patterns, including a cross-polarized lighting pattern and a parallel-polarized lighting pattern. In an embodiment, the cross-polarization lighting pattern and the parallel-polarization lighting pattern may be obtained based on a polarizer installed on a polarization-based light cage associated with the imaging setup 108.

In an exemplary embodiment, the object 118 may be at least one of the whiteboard or the body portion of a subject placed in the center of the imaging setup 108. The subject may be a human, the body portion may be a head, and the imaging setup 108 may be a polarization-based light cage. For instance, the object 118 may be the human head (with face) and the image 112 may be captured from the imaging setup 108 that may operate as a polarization-based light cage. The human head may be scanned via one or more cameras 116 of the imaging setup 108 from a plurality of viewpoints to obtain the image 112. In order to obtain high-fidelity reflectance and normal/height maps for the object 118, the object 118 must be exposed to different lighting patterns while capturing images (for example, the image 112) of the object 118 from different viewpoints.

In an embodiment, the circuitry 202 may obtain a specular map and a diffuse map based on a separation of specular and diffuse components from the texture maps associated with the image 112. Details of such methods have been omitted from the disclosure for the sake of brevity.

Alternatively, in an embodiment, the circuitry 202 may obtain a set of specular-separated gradient images based on a removal of a diffuse component from the captured image 112 that may be associated with the gradient lighting patterns. In another embodiment, the circuitry 202 may capture a test image (a test image 502 of FIG. 5) of the whiteboard (such as, the object 118) that may be placed at a center of the imaging setup 108. Further, to capture the test image 502, the whiteboard may face at least one camera of the set of cameras 116. Herein, the size of the whiteboard may correspond to a field of view of a camera that may capture the test image 502. Further, the test image captured may be in a linear color space or in a (Standard Red Green Blue) sRGB space converted to linear color space. In a case where the captured test image is in the sRGB space, a light intensity of pixels of the test image may correspond to the determined brightness distribution. Details related to determination of brightness distribution are further discussed later in step 304.

In an example, the circuitry 202 may capture, by use of the set of cameras 116 in an imaging setup 108, the image 112 of a human head with a face (such as, the object 118) that may be illuminated by the set of lighting patterns. Herein, the image 112 of the human head may include diffuse texture of a skin on the face, a neck and a chest region that may be exposed. Further, the circuitry 202 may determine brightness distribution of each pixel associated with the captured image 112 based on the diffused texture. Details related to determination of brightness distribution are further discussed later in step 304.

In some instances, when the object 118 is scanned to capture the image 112, the object 118 may need to stay still throughout the scanning phase. However, there may be some unavoidable movement (e.g., head movement) of the object 118. Actual between-frame movement may be assumed to be small. The rigid motion may be estimated and removed by performing patch matching between images or frames to obtain a set of motion-corrected images.

In an embodiment, the object 118 may be the human head and the image 112 may be captured from the imaging setup 108 that operates as a polarization-based light cage. The light cage may be, for example, a dome-shaped cage structure that may include a number of movable or static lighting devices and one or more cameras 116 placed at different locations on the cage structure. The cage structure may include the first structure 114A, the second structure 114B and the Nth structure 114N. The lighting devices may emit different lighting patterns based on one or more control signals from the electronic device 102 or from a standalone controller device. In case of the polarization-based light cage, the lighting devices may emit polarized light (cross or parallel polarization). The object 118 may be placed at the center of the spherical light cage and each camera may capture the image of the object 118, while the object 118 may be exposed to the set of lighting patterns. For example, the object 118 may be the human head or the whiteboard and the one or more cameras may capture image 112 of the object 118 under different lighting patterns.

At 304, a brightness distribution of the captured image 112 may be determined. The circuitry 202 may be configured to determine the brightness distribution of the captured image 112 based on a location (for example, camera location 304A) of at least one camera of the set of cameras 116. In an embodiment, the circuitry 202 may further be configured to determine the brightness distribution based on a 3D location of each pixel and a center of the imaging setup 108. The 3D location of each pixel 306A associated with the captured image 112 may be obtained based on determination of camera parameters. Further, the camera parameters may be associated with each camera of the set of cameras 116. Furthermore, the center of imaging setup 108 may be estimated based on the camera location 304A. Thereafter, circuitry 202 may be configured to compute distance of each pixel associated with the captured image 112 and the set of cameras 116 may be based on the obtained 3D location of each pixel from the estimated center of the imaging setup 108.

In an embodiment, the object 118 may be the whiteboard. Then, the captured image may be a test image of the whiteboard that is placed at a center of the imaging setup 108. Further, the whiteboard may face towards at least one camera of the set of cameras 116. In such a scenario, the brightness distribution of the test image may be determined based on the camera parameters associated with each camera of the set of cameras 116. The camera parameters may convert the test image (for example, a 2D image space) into the 3D mesh. Further, the real-world 3D location for each pixel of the test image may be determined based on the conversion of the 2D image into the 3D mesh. Further, the location of each camera of the set of cameras 116 in the imaging setup 108 (for example, a spherical light cage) may be computed to determine the center of the spherical light cage. Further, the circuitry 202 may be configured to determine the relationship between the determined brightness distribution and the estimated center of the spherical light cage. In an exemplary embodiment, the relationship between the brightness distribution and the center of the spherical light cage may be represented in a graphical form such as a polynomial curve.

Alternatively, in an embodiment, the object 118 may be a human face. The captured image 112 may include diffuse texture of a skin on the face, the neck and the chest region that may be exposed (based on an assumption that the skin of the human may be uniform across the face, the neck and the chest region). The imaging setup 108 may be the spherical light cage. In such a scenario, the circuitry 202 may be configured to determine the location of each camera of the set of cameras 116 in the spherical light cage to estimate the center of the spherical light cage. Further, the circuitry 202 may be configured to obtain the 3D location for each pixel of the captured image 112 to compute the distance from each UV pixel associated with the captured image 112 and the set of cameras 116 from the estimated center of the spherical light cage. Further, the circuitry 202 may be configured to determine the relationship between the determined brightness distribution and the estimated center of the spherical light cage. Furthermore, the relationship between the brightness distribution and the center of the spherical light cage may be represented in the graphical form such as the polynomial curve.

At 306, the distance of each pixel 306A of the captured image 112 and the set of cameras 116 may be computed. The circuitry 202 may be configured to compute the distance of each pixel 306A of the captured image 112 and the set of cameras 116. In an embodiment, the circuitry 202 may be configured to determine camera parameters associated with each camera of the set of cameras 116. Further, the circuitry 202 may be configured to obtain a 3D location of each pixel 306A of the captured image 112 based on the determined camera parameters. Furthermore, the computation of the distance of each pixel (for example, each pixel 306A of the captured image 112) associated with the captured image 112 and the set of cameras 116 may be based on the obtained 3D location of each pixel from the estimated center of the imaging setup 108.

For example, the imaging setup 108 may be the spherical light cage. Further, the circuitry 202 may be configured to obtain the 3D location of each pixel 306A of the captured image 112 based on the determined camera parameters. Furthermore, the circuitry 202 may be configured to compute the distance of each pixel 306A of the captured image 112 and the set of cameras 116 based on the obtained 3D location of each pixel from an estimated center of the spherical light cage.

In an embodiment, the circuitry 202 may further be configured to determine the brightness distribution based on the 3D location of each pixel 306A of the captured image 112 and the center of the imaging setup 108. The 3D location of each pixel 306A of the captured image 112 may be obtained based on determination of camera parameters. Further, the camera parameters may be associated with each camera of the set of cameras 116. Furthermore, the center of imaging setup 108 may be estimated based on the camera location 304A. Thereafter, circuitry 202 may be configured to compute distance of each pixel 306A of the captured image 112 and the set of cameras 116 may be based on the obtained 3D location of each pixel 306A of the captured image 112 from the estimated center of the imaging setup 108.

At 308, a light map may be generated. The circuitry 202 may be configured to generate the light map of the captured image 112 of the object 118 based on the determined brightness distribution (such as, at 304) and the computed distance of each pixel 306A of the captured image 112 and the set of cameras 116. In an embodiment, the circuitry 202 may be configured to determine a relationship between the determined brightness distribution and the estimated center of the imaging setup 108. Further, the circuitry 202 may be configured to generate the light map of the captured image 112 of the object 118 based on the determined relationship between the determined brightness distribution and the estimated center of the imaging setup 108. For example, the relationship between the determined brightness distribution and the estimated center of the imaging setup 108 may be represented in the graphical form such as the polynomial curve.

For example, the light map may be associated with the texture map applied to the object 118 to simulate an effect of a local light source (such as, the light source of the imaging setup 108). The light map may be a data structure associated with lightmapping. The light map may be form of surface caching in which the brightness of surfaces in a virtual scene may be pre-calculated and stored in texture maps. The light maps may allow addition of global illumination, shadows, and ambient lighting at a relatively low computational cost. The light maps may produce lighting effects at lower resolutions than normal textures.

In an embodiment, the object 118 may be the whiteboard. The image of the whiteboard may be captured and may be considered as a reference of the brightness distribution. The circuitry 202 may be configured to capture the test image (for example, the captured image 112) of the whiteboard that may be placed at the center of the imaging setup 108. Furthermore, the circuitry 202 may be configured to compute the distance of each pixel associated with the captured image (for example, each pixel 306A of the captured image 112) and the set of cameras 116 based on the obtained 3D location of each pixel from the estimated center of the imaging setup 108. The circuitry 202 may be configured to determine the brightness distribution of the test image based on the location of at least one camera of the set of cameras 116 to obtain the brightness distribution of each pixel. The circuitry 202 may be configured to generate the light map of the test image based on the obtained brightness distribution of each pixel.

Alternatively, in an embodiment, the object 118 may be the human face. Herein, skin of the human face may be considered as a reference of the brightness distribution. The circuitry 202 may be configured to capture image 112 of the human face that may be placed at the center of the imaging setup 108. Furthermore, the circuitry 202 may be configured to determine the brightness distribution of the captured image 112 based on the skin of the human face to obtain the brightness distribution of each pixel of the captured image 112 that includes human face. The circuitry 202 may be configured to generate the light map of the test image based on the obtained brightness distribution of each pixel 306A of the captured image 112 that includes human face.

At 310, a brightness intensity may be updated. The circuitry 202 may be configured to update the brightness intensity of a texture map associated with the captured image 112, based on the generated light map. In an embodiment, the circuitry 202 may be configured to update the brightness intensity of the diffuse texture map, and the specular texture map associated with the captured image 112. The update of the diffuse texture map, and the specular texture map associated with the captured image may update and thereby correct the brightness intensity, based on the generated the light map (such as, at 308). Since the light map may be generated based on a 3D location, the correction process does not introduce seam to the texture, so there may be no need for any post seam correction.

At 312, the captured image may be rendered. The circuitry 202 may be configured render the captured image 112 based on the updated brightness intensity of the texture map. In an embodiment, the circuitry 202 may be configured to render the captured image based on the updated brightness intensity of the diffuse texture map, and the specular texture map. The update of the diffuse texture map, and the specular texture map may lead to the update of the brightness intensity of the captured image 112 (as shown at 408, 410 of FIG. 4 and 508, 510 of FIG. 5).

For example, the image captured at 302 may be the test image of the whiteboard (such as, the object 118), the image 112 may be image of the human face, and the texture map of the captured image 112 may include an uneven brightness intensity in the diffuse texture map, and in the specular texture map. Herein, the image 112 may be stored on the database 106 of the server 104 or any different location. Therefore, the circuitry 202 may be configured to update the uneven brightness intensity of each pixel 306A of the captured image 112 based on the generated the light map (such as, at 308) of the captured image 112. Furthermore, the circuitry 202 may be configured to render the updated brightness intensity of the test image to display the captured image 112 with an even (or corrected) brightness intensity.

Typically, the creation of realistic human faces in digital form may involve the use of 3D face models and 2D surface textures. These models and textures may be derived from various sources, including laser scans and high-resolution photographs. The 3D shape and 2D texture of a face may be represented in a computational face space, which shows how each face differs from an average face in terms of these two aspects. The texture and shape of a face can be normalized or adjusted to match an average or standard. This process may involve morphing the texture maps from individual faces onto the average head shape and morphing the average texture onto the shape of each individual face. The normalization process has been found to increase the attractiveness of faces. In the past, methods have been developed to generate different types of maps, including diffuse, specular, normal, and height maps, from a spherical light cage. However, spherical light cages have uneven light distribution in different 3D locations across the cage, which contributes to the uneven texture maps that have this lighting effects baked in. To create a realistic rendering of human skin, textures used for the skin shader need to be carefully considered. Different parts of the body have different appearances, and these differences need to be taken into account when creating a diffuse map of the skin. Specular maps are also important in creating a photo-real face, as they determine the ‘look’ of a model and how it reacts to various lighting conditions.

In order to address the requirements, the present disclosure introduces a method to correct uneven lighting effect on the textured maps of the 3D object (such as, the object 118), for example, a face of a person. The present disclosure further introduces the creation of an evenly lit texture map of the 3D object 118 without any prior knowledge of the lighting conditions. Additionally, the present disclosure may produce an evenly lit texture for a face based on image of the whiteboard. This approach may be commonly used in case of texture maps correction for the image of a face or skin covered by tattoos or other features, as it may compensate for the uneven lighting and create consistency and well-lit texture map across the captured image 112.

FIG. 4 is a diagram that illustrates an exemplary scenario of light distribution correction based on image of body portion of a subject, in accordance with an embodiment of the disclosure. FIG. 4 is explained in conjunction with elements from FIG. 1, FIG. 2, and FIG. 3. With reference to FIG. 4, there is shown an exemplary scenario 400 that illustrates multiple steps included correction of light distribution from 402 to 410. The exemplary steps 402 to 410 may be executed by any computing system, for example, by the electronic device 102 of FIG. 1 or by the circuitry 202 of FIG. 2.

At 402, image capture of a subject may be performed. The circuitry 202 may be configured to capture, by use of the set of cameras 116 in the imaging setup 108, the image 112 of the subject that may be illuminated by the set of lighting patterns. For example, the subject may be the human head of an actor as shown in FIG. 4. The circuitry 202 may capture the image 112 of the face of the subject. The captured image 112 may include the diffuse texture of the skin on the face, neck and chest region of the subject (human head). The diffuse texture may be associated with each pixel skin detection. Details of method to detect per-pixel skin have been omitted from the disclosure for the sake of brevity.

At 404, a brightness distribution of the captured image 112 may be determined. The circuitry 202 may be configured to determine the brightness distribution of the captured image 112 based on the location of at least one camera of the set of cameras 116. In another embodiment, the brightness distribution of the captured image 112 may be determined based on the diffuse texture of the skin on the face, neck and chest region of the subject. The circuitry 202 may further determine brightness distribution of each pixel associated with the captured image 112 based on the diffused texture. Further, the circuitry 202 may be configured to estimate the center of the imaging setup 108 based on the location of at least one camera of the set of cameras 116. Furthermore, the circuitry 202 may determine the relationship between the determined brightness distribution and the estimated center of the imaging setup 108. In an exemplary embodiment, the relationship between the brightness distribution and the center of the imaging setup 108 may be represented in a graphical form such as a polynomial curve as shown at 404 in FIG. 4. For example, the captured image 112 may be the image of the face (on a human head) and imaging setup 108 may be the spherical light cage. Further, the circuitry 202 may determine the relationship between the determined brightness distribution and the estimated center of the spherical light cage. Details of methods of location detection of the set of cameras 116 have been omitted from the disclosure for the sake of brevity.

At 406, a light map may be generated. The circuitry 202 may be configured to generate the light map of the captured image 112 of the object 118 based on the determined brightness distribution (such as, at 304) and the computed distance of each pixel 306A of the captured image 112 and the set of cameras 116. In an embodiment, the circuitry 202 may be configured to determine a relationship between the determined brightness distribution and the estimated center of the imaging setup 108. Further, the circuitry 202 may be configured to generate the light map of the captured image 112 of the object 118 may be based on the determined relationship between the determined brightness distribution and the estimated center of the imaging setup 108. For example, the relationship between the determined brightness distribution and the estimated center of the imaging setup 108 may be represented in the graphical form such as the polynomial curve.

At 408, a corrected diffuse map may be generated. The circuitry 202 may be configured to update a brightness intensity of the diffuse map (as shown at 408) associated with the captured image 112, based on the generated light map (as shown at 406). Further, the circuitry 202 may be configured to render the captured image 112 based on the updated brightness intensity of the diffuse map. In an embodiment, the diffuse map may be associated with the base color (or an RGB color) of the 3D object 118.

At 410, a corrected specular map may be generated. The circuitry 202 may be configured to update the brightness intensity of the specular map associated with the captured image 112, based on the generated light map (as shown at 406). Further, the circuitry 202 may be configured to render the captured image 112 based on the updated brightness intensity of the specular map. In an embodiment, the specular map may be associated with gray scale of the image (or black and white image) that maps out the shininess intensity value on the 3D object 118. The specular map may determine the brightness intensity of each pixel based on the whiteness of each pixel (thus, the whiter the pixel, higher the brightness intensity.)

FIG. 5 is a diagram that illustrates an exemplary scenario of light distribution correction based on image of a whiteboard, in accordance with an embodiment of the disclosure. FIG. 5 is explained in conjunction with elements from FIG. 1, FIG. 2, FIG. 3, and FIG. 4. With reference to FIG. 5, there is shown an exemplary scenario 500 that illustrates multiple steps including correction of light distribution from 502 to 510. The exemplary steps 502 to 510 may be obtained by any computing system, for example, by the electronic device 102 of FIG. 1 or by the circuitry 202 of FIG. 2.

At 502, image capture of a subject may be performed. The circuitry 202 may be configured to capture, by use of the set of cameras 116 in the imaging setup 108, the image 112 of the subject that may be illuminated by the set of lighting patterns. For example, the subject may be the whiteboard as shown in FIG. 5. The circuitry 202 may capture the image 112 of the whiteboard as a test image. The whiteboard may be placed at the center of the imaging setup 108 facing at least one camera of the set of cameras 116. Further, the test image captured may be in the linear color space or in the sRGB space converted to the linear color space.

At 504, a brightness distribution of the captured image 112 may be determined. The circuitry 202 may be configured to determine camera parameters associated with each camera of the set of cameras 116. Further, the circuitry 202 may be configured to obtain the 3D location of each pixel associated with the test image based on the determined camera parameters. Furthermore, the computation of the distance of each pixel associated with the test image and the set of cameras 116 may be based on the obtained 3D location of each pixel from the estimated center of the imaging setup 108. For example, the imaging setup 108 may be the spherical light cage, and the distance of each pixel associated with the captured image 112 may be each pixel of the test image. Further, the circuitry 202 may be configured to obtain the 3D location of each pixel of test image based on the determined camera parameters. Furthermore, the circuitry 202 may be configured to compute the distance of each pixel of the test image and the set of cameras 116 based on the obtained 3D location of each pixel from the estimated center of the spherical light cage. Thereafter, the circuitry 202 may be configured to compute distance of each pixel of the test image and the set of cameras 116 that may be based on the obtained 3D location of each pixel of the test image from the estimated center of the spherical light cage.

In another embodiment, the circuitry 202 may determine the relationship between the determined brightness distribution and the estimated center of the spherical light cage. In an exemplary embodiment, the relationship between the brightness distribution and the center of the spherical light cage may be represented in a graphical form such as a polynomial curve as shown at 504 in FIG. 5. Details of such methods have been omitted from the disclosure for the sake of brevity.

At 506, a light map may be generated. The circuitry 202 may be configured to generate the light map of the test image of the whiteboard based on the determined brightness distribution (such as, at 504) and the computed distance of each pixel of test image and the set of cameras 116. In an embodiment, the circuitry 202 may be configured to determine the relationship between the determined brightness distribution and the estimated center of the spherical light cage. Further, the circuitry 202 may be configured to generate the light map of the test image based on the determined relationship between the determined brightness distribution and the estimated center of the spherical light cage. For example, the relationship between the determined brightness distribution and the estimated center of the spherical light cage may be represented in the graphical form such as the polynomial curve as shown at 504 in FIG. 5.

At 508, a corrected diffuse map may be generated. The circuitry 202 may be configured to update a brightness intensity of the diffuse map (as shown at 408) associated with the image 112 (that may be stored in the database 106), based on the generated light map (as shown at 406). Further, the circuitry 202 may be configured to render the image 112 based on the updated brightness intensity of the diffuse map associated with the test image. In an embodiment, the diffuse map may be associated with the base color (or RGB color) of the 3D object 118.

At 510, a corrected specular map may be generated. The circuitry 202 may be configured to update the brightness intensity of the specular map (as shown at 408) associated with the image 112 (that may be stored in the database 106), based on the generated light map (as shown at 406). Further, the circuitry 202 may be configured to render the captured image 112 based on the updated brightness intensity of the specular map associated with the test image. In an embodiment, the specular map may be associated with gray scale of the image (or black and white image) that maps out the shininess intensity value on the 3D object 118. The specular map may determine the brightness intensity of each pixel based on the whiteness of each pixel (thus, the whiter the pixel, higher the brightness intensity.)

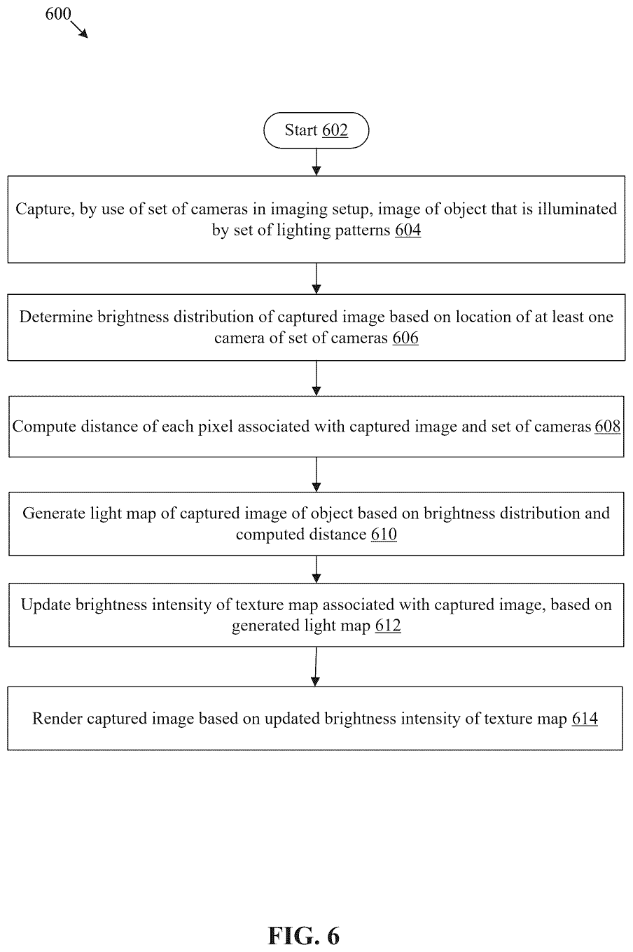

FIG. 6 is a flowchart that illustrates operations of an exemplary method for light distribution correction of uneven texture maps for three-dimensional (3D) objects, in accordance with an embodiment of the disclosure. FIG. 6 is described in conjunction with elements from FIG. 1, FIG. 2, FIG. 3, FIG. 3, FIG. 4, and FIG. 5. With reference to FIG. 6, there is shown a flowchart 600. The flowchart 600 may include operations from 602 to 614 and may be implemented by the electronic device 102 of FIG. 1 or by the circuitry 202 of FIG. 2. The flowchart 600 may start at 602 and proceed to 604.

At 604, an image that may be illuminated by a set of lighting patterns may be captured by use of a set of image capture devices. The circuitry 202 may be configured to capture, by use of the set of cameras 116 in the imaging setup 108, the image 112 of the object 118 that is illuminated by the set of lighting patterns. Details related to capturing the image 112 are provided, for example, in FIG. 3 (at 302).

At 606, a brightness distribution of the captured image may be determined based on a location of at least one camera of a set of cameras. The circuitry 202 may be configured to determine a brightness distribution of the captured image 112 based on a location of at least one camera of the set of cameras 116. Details related to the brightness distribution are provided, for example, at 304 in FIG. 3 (at 304).

At 608, distance of each pixel associated with the captured image and the set of cameras may be computed. The circuitry 202 may be configured to compute the distance of each pixel 306A associated with the captured image 112 and the set of cameras 116. Details related to distance computation are provided, for example, in FIG. 3 (at 306).

At 610, a light map of the captured image of the object may be generated, based on the brightness distribution and the computed distance. The circuitry 202 may be configured to generate a light map (for example, the light map 406 or the light map 506) of the captured image 112 of the object 118 based on the determined brightness distribution (for example, the brightness distribution at 404 or the brightness distribution at 504) and the computed distance at 606. Details related to light map generation are provided, for example, in FIG. 3 (at 308).

At 612, a brightness intensity of a texture map associated with the captured image may be updated, based on the generated light map. The circuitry 202 may be configured to update a brightness intensity of the texture map associated with the captured image 112, based on the generated light map at 610. Details related to brightness intensity update are further provided, for example, in FIG. 3 (at 310).

At 614, the captured image may be rendered, based on the updated brightness intensity of the texture map. The circuitry 202 may be configured to render the captured image 112 based on the updated brightness intensity (for example at 612) of the texture map. Details related to rendering of the captured image 112 are further provided, for example, in FIG. 3 (at 312). Control may pass to end.

Although the flowchart 600 is illustrated as discrete operations, such as, 604, 606, 608, 610, 612, and 614, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102 of FIG. 1). Such instructions may cause the electronic device 102 to perform operations that may include capture of, by use of a set of cameras (e.g., the set of cameras 116) in an imaging setup (e.g., the imaging setup 108) an image (e.g., the image 112) of an object (e.g., the object 118) that may be illuminated by a set of lighting patterns. The operations may further include determination a brightness distribution of the captured image 112 based on a location of at least one camera of the set of cameras 116. The operations may further include computation of a distance of each pixel (e.g., each pixel 306A) associated with the captured image 112 and the set of cameras 116. The operations may further include generation of a light map of the captured image 112 of the object 118 based on the determined brightness distribution and the computed distance. The operations may further include update of a brightness intensity of a texture map associated with the captured image 112 based on the generated light map. The operations may further include rendering of the captured image 112 based on the updated brightness intensity of the texture map.

Exemplary aspects of the disclosure may provide an electronic device (such as, the electronic device 102 of FIG. 1) that includes circuitry (such as, the circuitry 202). The circuitry 202 may be configured to capture, by use of a set of cameras (e.g., the set of cameras 116) in an imaging setup (e.g., the imaging setup 108), an image (e.g., the image 112) of an object (e.g., the object 118) that is illuminated by a set of lighting patterns. The circuitry 202 may be configured to determine a brightness distribution of the captured image 112 based on a location of at least one camera of the set of cameras 116. The circuitry 202 may be configured to compute distance of each pixel (e.g., each pixel 306A) associated with the captured image 112 and the set of cameras 116. The circuitry 202 may be configured to generate a light map of the captured image 112 of the object 118 based on the determined brightness distribution and the computed distance. The circuitry 202 may be configured to update a brightness intensity of a texture map associated with the captured image 112, based on the generated light map. The circuitry 202 may be configured to render the captured image 112 based on the updated brightness intensity of the texture map.

In an embodiment, the circuitry 202 may be further configured to generate a three dimensional (3D) mesh of the object 118 based on the capture of image 112 by use of the set of cameras 116 in the imaging setup 108, and determine a center of the imaging setup 108 based on the 3D mesh of the object 118.

In an embodiment, the object 118 may be at least one of a whiteboard or a body portion of a subject placed in the center of the imaging setup 108.

In an embodiment, the subject may correspond to a human, the body portion corresponds to a head, and the imaging setup 108 may be configured as a polarization-based light cage.

In an embodiment, the set of lighting patterns may include at least one of a cross-polarized omni-directional lighting pattern and gradient lighting patterns, or polarized lighting patterns including a cross-polarized lighting pattern and a parallel-polarized lighting pattern.

In an embodiment, the circuitry 202 may be further configured to obtain the cross-polarization lighting pattern and the parallel-polarization lighting pattern, based on a polarizer installed on a polarization-based light cage associated with the imaging setup 108.

In an embodiment, the circuitry 202 may be further configured to obtain a set of specular-separated gradient images based on a removal of a diffuse component from the captured image 112, wherein the captured image 112 may be associated with the gradient lighting patterns.

In an embodiment, the circuitry 202 may be further configured to capture a test image of a whiteboard that may be placed at a center of the imaging setup 108, wherein the whiteboard may be configured to face at least one camera of the set of cameras 116.

In an embodiment, the circuitry 202 is further configured to determine camera parameters associated with each camera of the set of cameras obtain a 3D location of each pixel 306A associated with the captured image 112 based on the determined camera parameters, and estimate a center of the imaging setup 108 based on the location of at least one camera of the set of cameras 116. The determination of the brightness distribution may be based on the obtained 3D location of each pixel and the estimated center of the imaging setup 108.

In an embodiment, computation of the distance of each pixel 306A associated with the captured image 112 and the set of cameras 116 may be based on the obtained 3D location of each pixel 306A from the estimated center of the imaging setup 108.

In an embodiment, the circuitry 202 may be further configured to determine a relationship between the determined brightness distribution and the estimated center of the imaging setup 108, wherein generation of the light map of the captured image of the object 118 may be further based on the determined relationship.

In an embodiment, the texture map may correspond to at least one of a diffuse texture map, a specular texture map, or a normal texture map.

The present disclosure may also be positioned in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
capture, by a set of cameras in an imaging setup, an image of an object that is illuminated by a set of lighting patterns;
determine a brightness distribution of the captured image based on a location of at least one camera of the set of cameras;
compute distance of each pixel associated with the captured image and the set of cameras;
generate a light map of the captured image of the object based on the determined brightness distribution and the computed distance;
update a brightness intensity of a texture map associated with the captured image, based on the generated light map; and
render the captured image based on the updated brightness intensity of the texture map.

2. The electronic device according to claim 1, wherein the circuitry is further configured to:
generate a three dimensional (3D) mesh of the object based on the capture of image by use of the set of cameras in the imaging setup; and
determine a center of the imaging setup based on the 3D mesh of the object.

3. The electronic device according to claim 1, wherein the object is at least one of a whiteboard or a body portion of a subject placed in a center of the imaging setup.

4. The electronic device according to claim 3, wherein
the subject corresponds to a human,
the body portion corresponds to a head, and
the imaging setup is configured as a polarization-based light cage.

5. The electronic device according to claim 1, wherein the set of lighting patterns includes at least one of:
a cross-polarized omni-directional lighting pattern and gradient lighting patterns, or
polarized lighting patterns including a cross-polarized lighting pattern and a parallel-polarized lighting pattern.

6. The electronic device according to claim 5, wherein the circuitry is further configured to obtain the cross-polarization lighting pattern and the parallel-polarization lighting pattern, based on a polarizer installed on a polarization-based light cage associated with the imaging setup.

7. The electronic device according to claim 5, wherein the circuitry is further configured to:
obtain a set of specular-separated gradient images based on a removal of a diffuse component from the captured image, wherein
the captured image is associated with the gradient lighting patterns.

8. The electronic device according to claim 1, wherein the circuitry is further configured to:
capture a test image of a whiteboard that is placed at a center of the imaging setup, wherein
the whiteboard is configured to face at least one camera of the set of cameras.

9. The electronic device according to claim 1, wherein the circuitry is further configured to:
determine camera parameters associated with each camera of the set of cameras;
obtain a 3D location of each pixel associated with the captured image based on the determined camera parameters; and
estimate a center of the imaging setup based on the location of at least one camera of the set of cameras, wherein
the determination of the brightness distribution is based on the obtained 3D location of each pixel and the estimated center of the imaging setup.

10. The electronic device according to claim 9, wherein the computation of the distance of each pixel associated with the captured image and the set of cameras is based on the obtained 3D location of each pixel from the estimated center of the imaging setup.

11. The electronic device according to claim 9, wherein the circuitry is further configured to:
determine a relationship between the determined brightness distribution and the estimated center of the imaging setup, wherein
the generation of the light map of the captured image of the object is further based on the determined relationship.

12. The electronic device according to claim 1, wherein the texture map corresponds to at least one of a diffuse texture map, a specular texture map, or a normal texture map.

13. A method, comprising:
in an electronic device:
capturing, by a set of cameras in an imaging setup, an image of an object that is illuminated by a set of lighting patterns;
determining a brightness distribution of the captured image based on a location of at least one camera of the set of cameras;
computing distance of each pixel associated with the captured image and the set of cameras;
generating a light map of the captured image of the object based on the determined brightness distribution and the computed distance;
updating a brightness intensity of a texture map associated with the captured image, based on the generated light map; and
rendering the captured image based on the updated brightness intensity of the texture map.

14. The method according to claim 13, wherein the set of lighting patterns includes at least one of:
a cross-polarized omni-directional lighting pattern and gradient lighting patterns, or
polarized lighting patterns including a cross-polarized lighting pattern and a parallel-polarized lighting pattern.

15. The method according to claim 14, further comprising:
obtaining a set of specular-separated gradient images based on a removal of a diffuse component from the captured image, wherein
the captured image is associated with the gradient lighting patterns.

16. The method according to claim 13, further comprising:
capturing a test image of a whiteboard that is placed at a center of the imaging setup, wherein
the whiteboard is configured to face at least one camera of the set of cameras.

17. The method according to claim 13, further comprising:
determining camera parameters associated with each camera of the set of cameras;
obtaining a 3D location of each pixel associated with the captured image based on the determined camera parameters; and
estimating a center of the imaging setup based on the location of at least one camera of the set of cameras, wherein
the determination of the brightness distribution is based on the obtained 3D location of each pixel and the estimated center of the imaging setup.

18. The method according to claim 17, wherein the computation of the distance of each pixel associated with the captured image and the set of cameras is based on the obtained 3D location of each pixel from the estimated center of the imaging setup.

19. The method according to claim 17, further comprising:
determining a relationship between the determined brightness distribution and the estimated center of the imaging setup, wherein
the generation of the light map of the captured image of the object is further based on the determined relationship.

20. A non-transitory computer-readable medium having stored thereon, computer-executable instructions that when executed by an electronic device, causes the electronic device to execute operations, the operations comprising:
capturing, by a set of cameras in an imaging setup, an image of an object that is illuminated by a set of lighting patterns;
determining a brightness distribution of the captured image based on a location of at least one camera of the set of cameras;
computing distance of each pixel associated with the captured image and the set of cameras;
generating a light map of the captured image of the object based on the determined brightness distribution and the computed distance;
updating a brightness intensity of a texture map associated with the captured image, based on the generated light map; and
rendering the captured image based on the updated brightness intensity of the texture map.
